(19) United States
(12) Patent Application Publication
(10) Pub. No.: US 2007/0122108 A1
(43) Pub. Date: May 31, 2007

(54) Selective recording for digital video recorders

(76) Inventor: Raymond C. Bontempi, Jamison, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/287,811

(22) Filed: Nov. 28, 2005

(51) Int. Cl. H04N 5/91

(52) U.S. Cl. 386/83

(57) ABSTRACT

Video programming is selected for recording on a digital video recorder (DVR) using an electronic program guide data interface for obtaining a list of video programs available to the DVR for recording. A preference engine filters entries from the list of video programs using a user recording history to thereby generate a filtered list of video programs. A DVR programming generator is utilized to generate programming for the DVR responsively to the filtered list of video programs.

### BACKGROUND

Digital video recorders (DVRs) have become increasingly popular for the flexibility and capabilities offered to users in selecting and then recording video content such as that provided by cable and satellite television service companies. DVRs, also called digital personal video recorders, are consumer electronic devices that record television programs which are saved to a hard disk drive (“HDD”) in digital format. Since being introduced in the late 1990s, DVRs have steadily developed complementary abilities, such as recording onto DVDs (digital versatile discs).

DVRs were first marketed as standalone electronic devices. Currently, many satellite and cable service providers are incorporating DVR functionality directly into their set-top-boxes (STBs). Service providers can thus readily implement features such as automatic hard disk space management whereby old recordings are deleted to make room for new ones; the maximum number of episodes to keep on weekly recordings may be specified; and, the maximum number of days or weeks to keep individual recordings may be set after which the recordings are deleted from the DVR.

Users may program DVRs to record television programs aired on specific channels and at specific times just as they would conventional analog video recorders such as video cassette recorders (VCRs). Note that while the term “program” may refer to a one-off broadcast of a show, it more generally refers to a series made up of individual episodes. DVRs may generally be programmed by the user to record preferred or desired programs by interacting with a programming interface that provides a variety of programming options to the user. For example, a user may choose to record episodes in a serial program by interacting with an electronic programming guide (EPG). The EPG includes a listing of upcoming programs and the DVR will then record the programs chosen by the user without further interaction. That is, the user need only to choose the program—for example, by title or by content that meets certain criteria selected by the user (actor, director, certain actor or director in a specific genre, certain sports team, or by specific keyword input, etc.)—and the DVR will record the programming on the appropriate channel at the correct time.

DVRs allow the “time shifting” feature (traditionally done by a VCR) to be performed more conveniently, and also provide for special recording capabilities such as pausing live television, instant replaying of interesting scenes, and skipping advertising. All episode recording (commonly called “all-season” or “season-pass” recording) enables a user to record every episode of a serial program, regardless of the time it is showing, and with the ability of the DVR to automatically differentiate between new and repeat episodes. Given the large storage capacity of most DVRs and the number of channels that are available on many cable and satellite systems, a wide variety of favorite shows, episodes and programs of a user may be readily and conveniently recorded for later viewing.

While current DVR programming arrangements are satisfactory for many applications, more capable and sophisticated approaches to DVR recording are desirable.

### BRIEF DESCRIPTION OF THE DRAWING

FIG. 1 is a block diagram of an illustrative selective recording arrangement;

FIG. 2 is a block diagram showing details of a programming source;

FIG. 3 is a block diagram showing a programming source and an alternate metadata source with network connections to a selective recording arrangement;

FIG. 4 is a flow chart for an illustrative method for providing DVR recording options for programs that are simultaneously in first run and rerun;

FIG. 5 is a flow chart showing an illustrative method for providing a DVR recording option using a prohibited content list; and

FIG. 6 is a flow chart showing another illustrative method for providing a DVR recording option using a prohibited content list.

### DETAILED DESCRIPTION

Television programming generally comprises network programming and syndicated programming. Network programming is sold and then broadcast on networks and is usually guaranteed to run on all of the network's affiliates on the same day of the week and at the same time (in a given time zone). With the advent of cable television, there has been a large increase in the number of television networks. The most prevalent form of show on network television is the episodic serial program which has a continuing set of characters and settings with a different plot in each episode of the program series.

In many countries, and particularly in the United States, episodic serial programs run on a network during a certain season, generally from early September until late May. Networks often repeatedly air previous episodes of a program during the hiatus between seasons. An episode is considered a first run when it is aired for the first time. A repeated airing of an episode is commonly called a “repeat or a “rerun.” Both terms are used interchangeably.

Syndication is a term that typically refers to the sale of the right to broadcast television reruns (without going through a network) by a production or distribution company. When syndicating a show, the production company attempts to sell the show to buyers in multiple markets. Typically, a buyer is a cable television channel or a local television station.

Syndication comes in several forms including the common strip or daily syndication where episodes of a television series are shown daily. Other forms of syndication include weekly syndication where a rerun is aired weekly. First run syndication is where a program is broadcast for the first time as a syndicated show. Common examples of first run syndicated programming are game shows.

Current DVRs typically provide a number of user-selectable options for recording episodic programming. These recording options allow the DVR to be set to record: i) first run episodes only; ii) both reruns and first run episodes; and, iii) all episodes of a show (including duplicate episodes). When a user selects the first run only option, a DVR is set to record only first run episodes of a program. Some DVRs will consider an episode a first run if a previously aired program on one network is being shown for the first time on a different network or channel.

When a user selects the option of recording both rerun and first run episodes, the DVR commonly is set to record all episodes from all available channels—whether first run or rerun—as they air over time. Some current DVRs will exclude episodes from being recorded if they have previously been recorded by the DVR within some time period, for example, the past 28 days.

When a user selects the option of recording all episodes, then the DVR typically records each episode that airs on each of the available channels (even episodes, for example, that have been previously recorded by the DVR within the past 28 days). Some DVRs provide additional recording options that can limit the number of episodes actually recorded by the DVR when the “Record All” option is selected. One such additional recording option provided to users is an ability to set a maximum number of episodes in a series that are recorded (i.e., “a Keep at Most” option). Another recording option (i.e., a “Keep Until” option) gives users an ability to set the DVR to keep a recorded episode on the DVR's hard disk drive until the user either manually deletes the episode, or alternatively until more recording space is needed once the HDD is full.

While these current DVR recording options present an improvement over the very simple programming capabilities of a VCR, such recording options are limited with regard to the selection and management of rerun recordings. Such limitations can lead to undesirable DVR recording behavior whereby the user's recording preferences are not met. Given that recording space is finite, most DVRs will either stop making recordings once the hard disk is full, or alternatively, delete the oldest recorded episodes as disk space is needed to record new episodes. As it can often be difficult for users to gauge the amount of free HDD space on the DVR, shows are either missed or prematurely deleted from the DVR, or too many shows are recorded.

For example, if a user sets the DVR to record a desired program but does not have a chance to watch it for some reason, it is possible that it will be recorded over as the DVR operates to record other programs selected by the user to record. Likewise, it is possible that desired programs are not recorded because the DVR's HDD is completely full. Such situations can be very frustrating to users. Particularly so when the DVR is not recording, or recording over desired programming to deal with reruns that are unwanted but get recorded nonetheless due to the limitations of current DVR recording options.

More specifically, the current “first run only” or “first run and reruns” recording options do not provide sophisticated enough filtering to deal with two DVR recording scenarios: 1) recording programs that are simultaneously in first run and in reruns; and 2) recording programs that are aired frequently in reruns.

In the first scenario, new episodes of the program are produced and aired on a television network. And at the same time, syndicated reruns of the program are shown on several other channels such as those carried by cable and satellite services. A contemporary example is the “Simpsons” animated series which is in current production on the FOX network and is also in syndicated reruns (©1999-2005 20th Century Fox Film Corp).

In the second scenario, syndicated reruns are shown on many channels. As a result, a typical cable or satellite television subscriber might have dozens of airings of reruns of a particular program per week, often with a significant overlap of episodes. For example, a popular comedy show might be aired every day of the week on five different channels at different times with the same set of episodes shown on each channel. An example is the “Seinfeld” comedy series which was originally produced on NBC and is now widely carried in syndicated reruns on both local broadcast and cable channels (©1989-2005 Castle Rock Entertainment, Inc.).

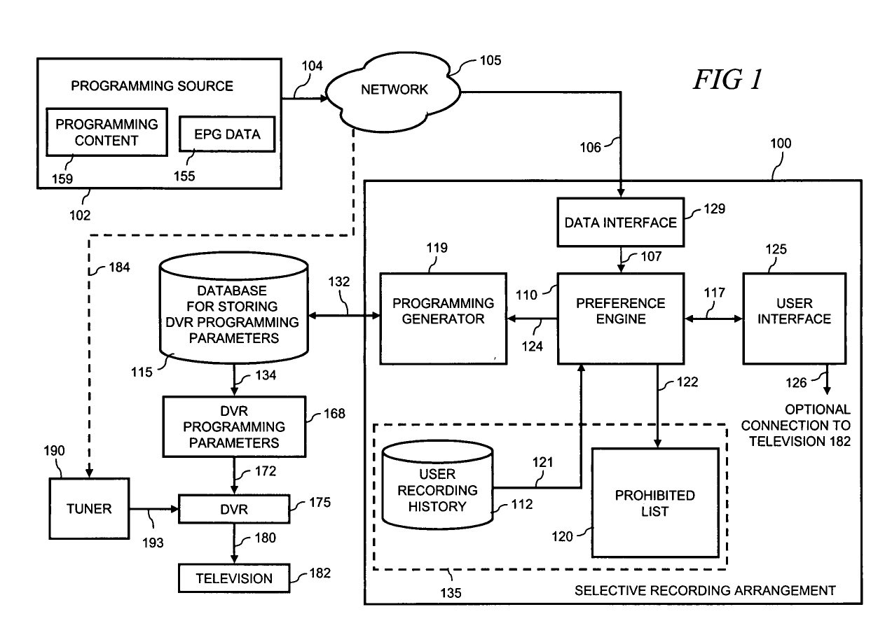

Referring now to FIG. 1, a block diagram of an illustrative selective recording arrangement 100 is shown. Selective recording arrangement 100 is coupled on line 132 to a database 115 that stores DVR programming parameters. Database 115 is typically implemented in a memory. DVR programming parameters 168 are output on line 134 by database 115 and received by a DVR 175 on line 172. A television 182 is coupled to the DVR 175 on line 180. DVR 175 is implemented using a standalone device, for example, or alternatively is incorporated with a STB in an integrated arrangement.

Selective recording arrangement 100 is utilized to generate DVR settings that are responsive to a DVR user's recording preferences for television programming, including episodic serial programming. In this illustrative example, selective recording arrangement 100 is implemented using a variety of known techniques and is typically embodied using software running on a processor such as a general purpose or application specific processor or using firmware.

In some applications, it may be desirable to incorporate selective recording arrangement 100 in a STB as a standalone component. Or, features and functions (as described in detail below) of selective recording arrangement 100 are alternatively integrated within other existing processors or circuitry in the STB.

Selective recording arrangement 100 is alternatively implemented as a network element, for example, as part of a hardware/software suite in a head end of a cable television network. In this implementation, the processing is performed remotely from the user's location but utilizes a local user interface such as a user interface that operates with a STB, DVR or DVD player.

As shown in FIG. 1, selective recording arrangement 100 includes a preference engine 110 which is coupled to a data interface 129 on line 107. Data interface 129 is arranged to receive EPG data 155 on line 106 from network 105. As described in more detail below, EPG data 155 is indicative of currently available programs and programs that will be aired in the future that are recordable by DVR 175.

EPG data 155 is typically sent within the television broadcast transport stream or alongside it in a special data channel from an EPG source which is remote from selective recording arrangement 100. Accordingly, a programming source 102, which is comprised of a head end or server, for example, supplies EPG data 155 and television programming content 159 to network 105 on line 104. Network 105 is embodied, for example, as a cable television network (i.e., community area television or “CATV” network), a satellite television network, or an over-the-air broadcast television network.

Television tuner 190 is coupled to receive television programming content 159 from programming source 102 from network 105 on line 184. DVR 175 is arranged to receive television programming from the television tuner 190. Alternatively, television tuner 190 may be incorporated into a STB in applications using a STB. Another alternative configuration is for television tuner 190 to be incorporated into selective recording arrangement 100.

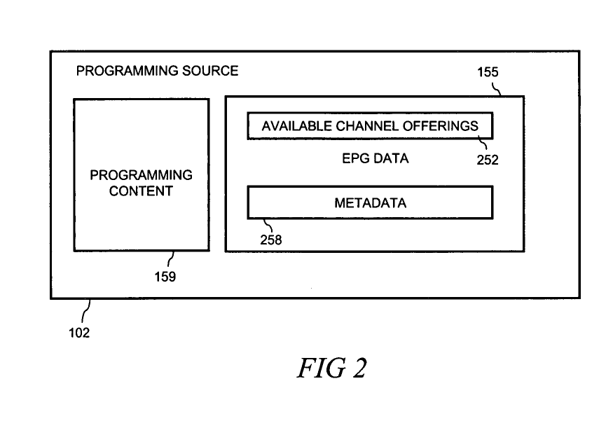

In this illustrative example, as shown in more detail in FIG. 2, EPG data 155 includes two components: available channel offerings 252 and metadata 258. The available channel offerings 252 portion of the EPG data 155 is used, typically by an application which resides on a STB, to generate an on-screen guide which is displayed on a television coupled to the STB. By navigating through the EPG and interacting with an input device such as STB remote control, users can see more information about current programming and future programs. EPGs thus conveniently enable a viewer to plan their viewing and record broadcast programs to a DVR for later viewing.

Metadata 258 includes descriptive data about program content. This data may include, for example, program title and synopsis, actors, directors, year of production, the channel name, the program start times, genres (i.e., western, mystery, science-fiction, sports, news, talk etc.) and other descriptive information. Metadata is generally used to help users to find, navigate and manage content from the variety of television channels and other sources such as pay-per-view and video-on-demand services.

EPG data 155 is transported as part of the encoded video stream depending on the specific EPG implementation in a digital television environment. For example EPG data may be transported as described by the Advanced Television Systems Committee (ATSC) PSIP (Program and System Information Protocol) standard. In analog implementations, EPG data 155 is included in the analog television signal, for example in the vertical blanking interval.

In some applications, an EPG source aggregates EPG data 155 from multiple EPG data providers. Alternatively, third party “metadata aggregators” which include companies such as Tribune TV Data or Gemstar TV Guide are used to provide EPG data content.

In typical applications, EPG data 155 is used to display programming information and descriptive metadata on a television as noted above. The EPG is often displayed using a grid or table format on the television with options provided to the user to select more information on each program displayed. Using the remote control, users may also search through the program listings in the table, for example, by day/time, channel, program name, or by using other search criteria.

The metadata 258 component of EPG data 155, in this illustrative example, describes a program type (i.e., rerun or first run). Some EPG providers include an explicit program type by using metadata tags such a “rerun” and “first run” which may be displayed in the EPG grid for some of all of the programs listed. Other EPG providers track the first air date for programs in the metadata 258. In this case, if the first air date is in the past, then selective recording arrangement 100 (FIG. 1) can determine that the program associated with the metadata is a rerun. If the first air date corresponds to the present day or a future date, then the associated program is determined to be a first run.

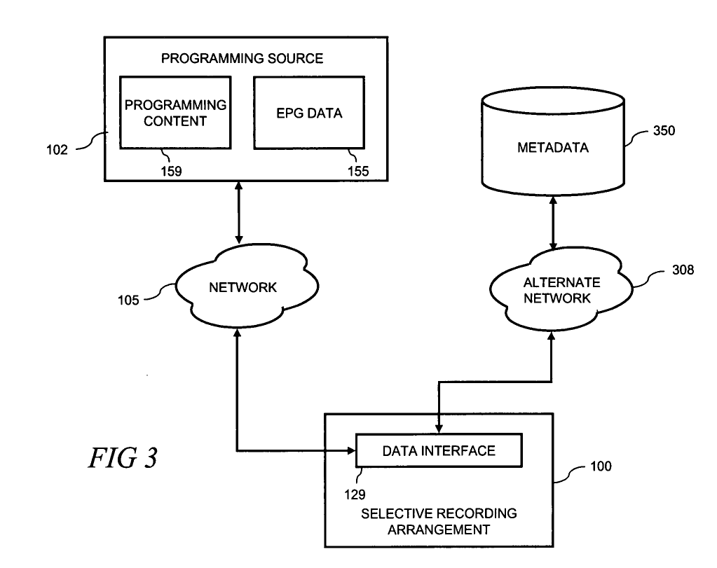

The use of an alternative metadata source 350 is shown in FIG. 3. Metadata source 350 is coupled to data interface 129 in selective recording arrangement 100. Metadata source 350 provides metadata as an alternative to the metadata that is encoded with the EPG data 155 from programming source 102. In some applications, it may be desirable to use descriptive information about video content from a metadata source which is separate from other EPG data 155. For example, EPG data 155 may be supplemented in cases where the metadata 258 component of EPG data 155 is incomplete for some or all programs. In some applications, metadata 158 may be replaced altogether with metadata from the alternative source metadata source 350.

Metadata source 350, in this illustrative example, is a database that is located remotely from selective recording arrangement 100. Metadata source 350 is coupled to data interface 129 using an alternate network 308, for example, a local area network, wide area network or the Internet.

Returning to FIG. 1, preference engine 110 is coupled to user interface 125 over line 117. User interface 125 is arranged to present selective recording options to a user and receive user input responsive to the selective recording options. Preferably, the user interface 125 is arranged as a graphical user interface. In some applications, user interface 125 can be optionally hosted using television 182 as the display device. This feature is implemented using the optional connection 126 between user interface 125 and television 182. A remote control, keyboard or other input device (not shown in FIG. 1) is included, in most applications, as part of user interface 125 to facilitate the receipt of user inputs.

A user recording history 112 is coupled to preference engine 110 on line 121. In this illustrative example, user recording history 112 is embodied in a memory that is accessed by preference engine 110. User recording history 112 is optionally combined with prohibited list 120 (described below) in a single memory which may desirable in some applications to efficiently package memory resources. This optional packaging configuration is indicated by the dashed rectangle 135 shown in FIG. 1. User recording history 112 is also optionally combined with database 115.

User recording history 112 is utilized to generate a prohibited content list to filter out programming from DVR recording to better meet users' needs and preferences. This feature is described in detail in the text accompanying FIGS. 5 and 6 below.

Preference engine 110 is coupled to a program generator 119 on line 124, as shown in FIG. 1. Programming generator 119 generates programming commands to set DVR 175 to record responsively to the operation of preference engine 110.

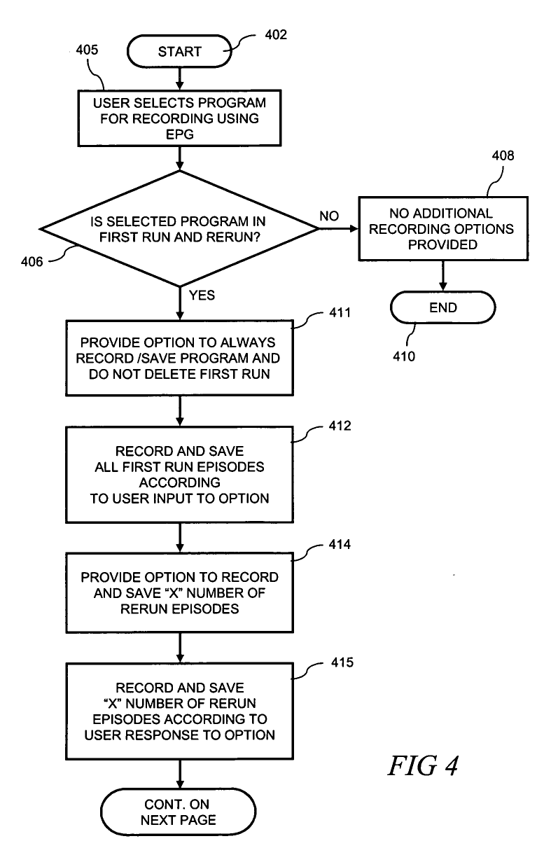

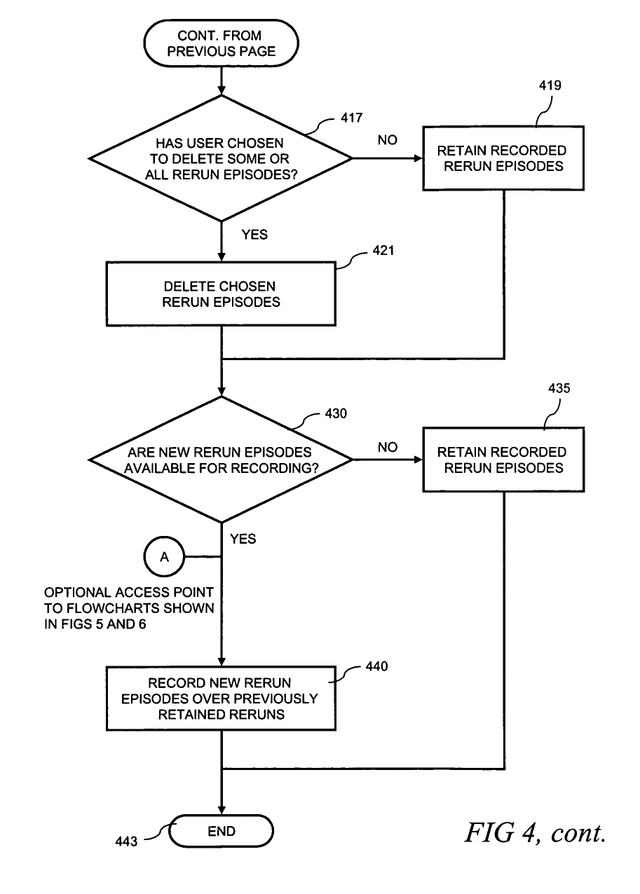

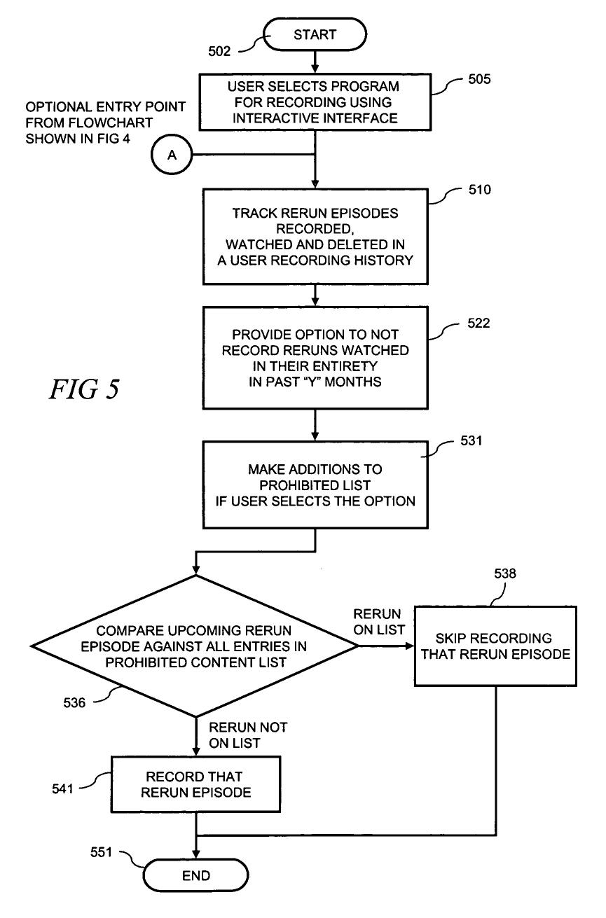

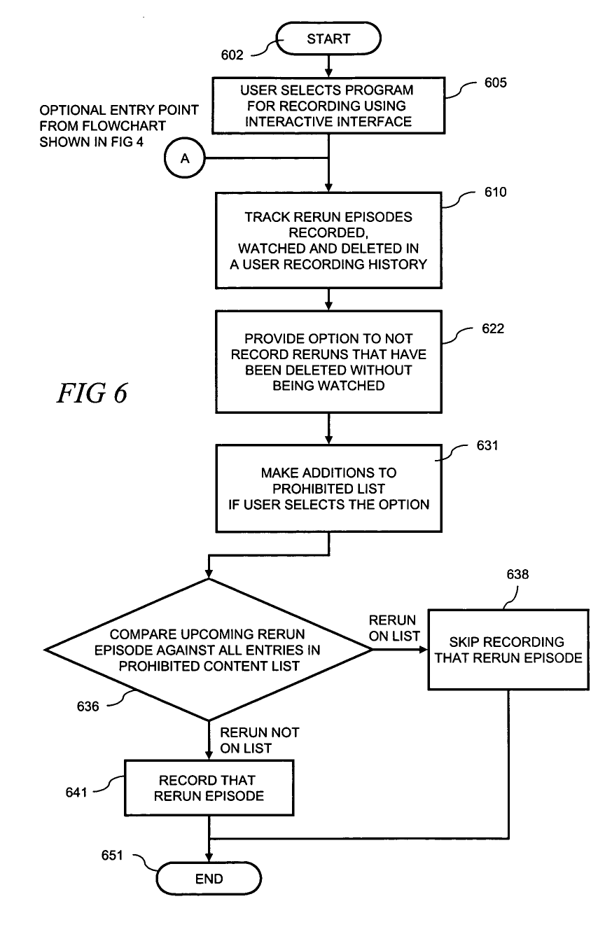

FIG. 4 shows a flow chart for an illustrative example of operation of selective recording arrangement 100 (shown in FIG. 1 and described in the accompanying text). In this illustrative example, DVR recording options are provided to a user for addressing the first DVR recording scenario noted above, namely the recording of programs that are simultaneously in first run and in reruns.

The process starts at block 402. At block 405, by interacting with an EPG through user interface 125, a user selects an episodic serial program for recording on DVR 175. At decision block 406, preference engine 110 uses metadata 258, or alternatively metadata from metadata source 350, to determine whether the program selected by the user has episodes that are being aired in both first run and rerun. If not, the process ends at block 410.

If the program selected by the user includes episodes that are being aired as both first run and reruns, then control passes to block 411 where a recording option is provided to the user through user interface 125 to always record and save the first run episode on DVR 175. The first run episode will not be deleted from the DVR 175 unless the user manually deletes it.

At block 412, a user input from user interface 125 is received by preference engine 110 in response to the recording option presented to the user. The user can choose to select the option to always record and save the first run episode of the program selected in block 205 without deletion, or ignore the recording option. If the option is selected, then programming generator 119 generates DVR programming parameters 168 which are stored in database 115. The DVR programming parameters 168 are passed to DVR 175 to set it to record the appropriate first run episode on the correct channel at the time it is aired.

At block 414, a recording option is provided to the user by preference engine 110 through user interface 125 to record and save a user-selectable number of rerun episodes on DVR 175. This user-selectable number is represented by the variable “X” in blocks 414 and 415.

At block 415, a user input from user interface 125 is received by preference engine 110 in response to this recording option presented to the user. A user can choose to select the option to record some number of rerun episodes of the program selected in block 405, or ignore the option. If the recording option is selected, then the user is prompted to specify (i.e., select) the number of rerun episodes that should be recorded and saved by DVR 175.

Programming generator 119 generates DVR programming parameters 168 which are stored in database 115. The DVR programming parameters 168 are passed to DVR 175 to set it to record the appropriate rerun episodes as they are aired.

At decision block 417, through user interface 125, preference engine 110 checks if the user wishes to delete some or all previously recorded rerun episodes from DVR 175. If so, then control passes to block 421 and programming generator 119 generates DVR programming parameters to set DVR 175 to delete the chosen rerun episodes from DVR 175. Recorded rerun episodes are retained on DVR 175 unless chosen for deletion as indicated by block 419 in FIG. 4.

At block 430, preference engine 110 reviews EPG data 155 (or if an alternative metadata source is used, then metadata 350 is reviewed) to determine if other rerun episodes of the program selected by the user in block 405 will be aired in the future. Preference engine 110 performs such review and determination periodically (i.e., iteratively over time) so that as new rerun episodes of the selected program (i.e., those not yet aired) become available they are recorded by DVR 175. If EPG data 155 indicates that rerun episodes will be aired, then as indicated by block 231, program generator 119 generates DVR operating parameters 168 that are passed to DVR 175 to set it to record the appropriate rerun episode on the correct channel at the time it is aired.

In this illustrative example, DVR 175 records the new rerun episodes over the old rerun episodes (i.e., those previously recorded) to efficiently utilize DVR hard disk space. Typically, DVR 175 is set to first record new rerun episodes over the oldest rerun episodes (i.e., those having been stored on DVR 175 for the longest period of time) with the next new rerun episode then recorded over the next youngest rerun episode recorded and stored on DVR 175, and so on, as new rerun episodes are aired.

Optionally, DVR operating parameters 168 are configured to set DVR 175 to record new rerun episodes on free hard disk space while retaining old rerun episodes. In this optional case, DVR 175 will eventually run out of free hard disk space and is typically configured to make no further recordings until old rerun episodes are manually deleted by the user. In some applications, a user selectable configuration is enabled in selective recording arrangement 100 in which the user selects, through user interface 125, whether DVR 175 records over old rerun episodes or records on free hard disk space.

If upon review of the EPG data 155 preference engine 110 determines that new rerun episodes are not being aired, then the previously recorded rerun episodes are retained on DVR 175, as shown in block 435. The process ends at block 443.

As shown in FIG. 4, optional control point “A” is disposed between blocks 430 and 440 to optionally pass process control to block 510 in FIG. 5. In some applications, it may be desirable at this point to enter the process shown in FIG. 5, as described in more detail below, to provide additional rerun recording options to the user.

FIGS. 5 and 6 show flow charts for two illustrative examples of operation of selective recording arrangement 100 (shown in FIG. 1 and described in the accompanying text) for which DVR recording options using a prohibited list are provided. In each of these illustrative examples, a DVR recording option is provided to a user for addressing the second DVR recording scenario described above, namely the recording of programs that are aired frequently in reruns.

It is noted that recording options shown in FIGS. 5 and 6 are independent from each other. The recording options may be provided to the user in a parallel manner at the same time, or in series, one at a time. Order does not matter and either or both recording options may be implemented according to the specific requirements of the application.

In FIG. 5, the illustrative process starts at block 502. At block 505, by interacting with an EPG and user interface 125, a user selects an episodic serial program for recording on DVR 175. At this point in the process, an optional entry point from the illustrative process shown in FIG. 4 is provided at point “A”, as shown.

At block 510, user recording history 112 is tracked. A user recording history includes a log of the identities of programs that are recorded by DVR 175 over a time period, and further includes the user's treatment of the logged programs—i.e., whether the recorded programs were watched, or deleted from DVR 175 without being watched.

In this illustrative example, preference engine 110 utilizes user recording history 112 to create a prohibited list 120 of program episodes that will not be recorded by DVR 175. A user is provided with a selectable recording option to set preference engine 110 to populate the prohibited list 120 with the identities of rerun episodes that have previously been recorded but deleted before being watched. The user is also provided with a selectable recording option to set preference engine 110 to populate the prohibited list 120 with the identities of rerun episodes that have been substantially fully viewed within some time period.

The process continues at block 522 where a recording option is provided by preference engine 110 to the user. Through user interface 125, the user is provided with the option to set DVR 175 to not record (i.e., skip recording) a rerun episode of the program selected by the user in block 505 if that rerun episode was previously recorded by DVR 175 and watched substantially in its entirety within a particular time interval. The time interval is optionally user-selectable through user interface 125 in this illustrative example. At block 522, the user-selectable time interval is represented by the variable “Y months.” This is illustrative, however, as other time increments (e.g., weeks, days, hours, etc.) may also be used depending on the specific requirements of an application.

At block 531, a user input from user interface 125 is received by preference engine 110 in response to the recording option presented to the user. Thus, a user can select the option to skip recording previously recorded and watched episodes, or ignore the option. If the recording option is selected by the user, then appropriate entries will be made to the prohibited list 120 as indicated in block 531.

When an episode of the program selected by the user in block 505 is going to be aired as indicated by EPG data 155, and thus becomes available to be recorded by DVR 175, then as shown in decision block 536 the upcoming rerun episode is compared against entries in the prohibited list 120. If the rerun episode is on the prohibited list 120, then the rerun episode is skipped and not recorded by DVR 175 as indicated by block 538. If the rerun episode is not on the prohibited list 120, then programming generator 119 generates DVR programming parameters 168 so that DVR 175 records the upcoming rerun episode when aired, as indicated by block 541. Accordingly, program generator 119 generates DVR programming parameters 168 that are passed to DVR 175 to set it to record the appropriate rerun episode on the correct channel at the time it is aired. The process ends in block 551.

As in the illustrative example shown in FIG. 4 and described in the accompanying text, in this illustrative example, DVR 175 records the new rerun episodes over the older rerun episodes—oldest to youngest—to efficiently utilize DVR hard disk space. Alternatively, DVR operating parameters 168 are configured to set DVR 175 to record new rerun episodes on free hard disk space while retaining old rerun episodes.

A specific example of the recording option shown in FIG. 5 is now described. In block 505, a user decides to record a fictional episodic series called “A History of Cooking” on DVR 175 by interacting with an EPG and user interface 125. When presented with the recording option in block 522, the user chooses to select the option so that rerun episodes of the program are selectively recorded by DVR 175 and that rerun episodes watched in their entirety in the last month (i.e., Y=1) will not be recorded.

On a Monday, a rerun episode of the series entitled “The History of Cooking: Italy” is aired on channel 121 at 5:00 pm which is recorded by DVR 175. Preference engine 110 makes an entry to user recording history 112 which indicates that the rerun episode was recorded by DVR 175. It is noted that most EPG providers give each episode in a series a unique program identifier (Program ID) that is carried in EPG data 155. In most applications, the Program ID is a numeric value. It is this Program ID that is typically entered into the user history 112.

The user watches the episode “A History of Cooking: Italy” recorded earlier substantially in its entirety later on that Monday at 7:30 pm. Preference engine 110 makes an entry into the user recording history 112 which indicates that the Italian cooking episode was watched substantially in its entirety.

Preference engine 110 also places an entry into prohibited list 120 (for example, the Program ID for the episode) which identifies the rerun episode “The History Cooking: Italy” in the episodic series “The History of Cooking” at block 531 in FIG. 5. Preference engine 110 performs this action because the user selected the recording option (presented in block 522) where previously watched reruns are not recorded again. For purposes of this example, it is assumed that the prohibited list 120 contains a single entry to identify the episode “The History of Cooking: Italy.”

When an additional episode of “The History Cooking” is indicated by the EPG data 155 as upcoming, then preference engine 110 compares the upcoming rerun episode against entries in prohibited list 120 as shown in decision block 536. If the upcoming episode is “The History of Cooking: Italy” then it will be skipped and not recorded by DVR 175 because this episode was previously recorded by DVR and watched by the user and is thus on prohibited list 120 as indicated in block 538. If, for example, the upcoming rerun episode is another episode in the series—“The History of Cooking: Japan”— then this episode would be recorded by DVR 175 because it is not on the prohibited list 120, in this example, as indicated in block 541.

Referring now to FIG. 6, another illustrative operative process for selective recording arrangement 100 is shown. The process starts at block 602. At block 605, by interacting with an EPG and user interface 125, a user selects an episodic serial program for recording on DVR 175. At this point in the process, an optional entry point from the illustrative process shown in FIG. 4 is provided at point “A”, as shown. At block 610, user recording history 112 is tracked. The operations in blocks 605 and 610 are similar to those described in blocks 505 and 510 in FIG. 5.

At block 622, a recording option is provided to the user through user interface 125 to not record (i.e., skip recording) certain rerun episodes of the program selected by the user in block 605. With this option, a rerun episode is skipped and not recorded by DVR 175 if that rerun episode has previously been recorded by DVR 175, but deleted from DVR 175 by the user without being watched.

At block 631, a user input from user interface 125 is received by preference engine 110 in response to the recording option presented to the user. Thus, a user can select the recording option for DVR 175 to skip recording previously recorded episodes which were deleted without being watched, or ignore the option. If the recording option is selected by the user, then appropriate entries will be made to the prohibited list 120 as indicated in block 631.

The remainder of the flow chart is similar to that shown in FIG. 5. With this recording option, when an episode of the program selected by the user in block 605 is going to be aired as indicated by EPG data 155, the upcoming rerun episode is compared against the prohibited list 120, as shown in block 636. If the rerun episode is on the prohibited list 120, then the rerun episode is skipped and not recorded by DVR 175 as indicated by block 638. If the rerun episode is not on the prohibited list 120, then programming generator 119 generates DVR programming parameters 168 so that DVR 175 records the upcoming rerun episode when it is aired, as indicated by block 641.

Program generator 119 generates DVR programming parameters 168 that are passed to DVR 175 to set it to record the appropriate rerun episode on the correct channel at the time it is aired. Newly recorded rerun episodes are recorded over old recorded reruns as described above. Alternatively, newly recorded rerun episodes are recorded on available free disk space on DVR 175.

A specific example of the recording option shown in FIG. 6 is now described. In block 605, a user decides to record a fictional episodic series called “Immortals in Baseball” on DVR 175 by interacting with an EPG and user interface 125. When presented with the recording option shown in block 622, the user chooses to select the recording option so that rerun episodes of the program are selectively recorded by DVR 175.

On a Wednesday, a rerun episode of the series entitled “Immortals in Baseball: Babe Ruth” is aired on channel 114 at 7:30 pm which is recorded by DVR 175. An entry to user recording history 112 is made by preference engine 110 which indicates that the rerun episode was recorded by DVR 175. The user later deletes the episode but never watches it. Preference engine 110 makes an entry into the user recording history 112 which indicates that the Babe Ruth episode was deleted without being watched.

Preference engine 110 also places an entry into prohibited list 120 ((for example, the Program ID for the episode) which identifies the rerun episode “Immortals in Baseball: Babe Ruth” in the episodic series “Immortals in Baseball” as shown in block 631. Preference engine 110 performs this action because the user selected the recording option (presented in block 632) where previously recorded episodes which were deleted without being watched are not recorded again. For purposes of this example, it is assumed that the prohibited list 120 contains a single entry to identify the episode “Immortals in Baseball: Babe Ruth.”

When an additional episode of “Immortals in Baseball” is indicated by the EPG data 155 as upcoming, then preference engine 110 compares the upcoming rerun episode against entries in prohibited list 120 as indicated in block 636. If the upcoming episode is “Immortals in Baseball: Base Ruth” then it will be skipped and not recorded by DVR 175 (as shown in block 638) because this episode was previously recorded by DVR but deleted by the user without being watched and is thus on prohibited list 120. If the upcoming rerun episode is another episode in the series—“Immortals in Baseball: Pete Rose”— then this episode is recorded by DVR 175 because it is not on the prohibited list 120, in this example, as shown in block 641.

It is emphasized that while the illustrative examples above dealt with episodic serial programming, the principles and benefits of the methods described are equally applicable to one-off programs (which are typically called “specials”) and other programs such as movies, news and sports that are not normally presented as part of a series. The principles and benefits may also be applied, for example, to programs that are related in ways other than being episodes in a program series. To name just a few examples, selective recording may be applied to programs that are related by network such as movies that are broadcast on the same “classic movie” channel, or by genre such as do-it-yourself programs that are shown on different home improvement cable television channels. In each case, users using selective recording are beneficially provided with greater control over the recording by a DVR of programs that are simultaneously in first run and rerun, as well as programs that are aired frequently as reruns.

1. Selective recording apparatus, comprising:
an electronic program guide data interface for obtaining a list of video programs available to a DVR for recording;
a preference engine for filtering entries from the list of video programs using a user recording history to generate a filtered list of video programs; and
a DVR programming generator for generating, responsively to the filtered list of video programs, programming for the DVR.

2. The selective recording apparatus of claim 1 where the preference engine uses electronic programming guide metadata to determine which entries in the list of video programs are reruns.

3. The selective recording apparatus of claim 1 where the filtered list includes a prohibited list stored in a memory coupled to the preference engine, the prohibited list identifying video programs to be skipped by the DVR programming generator when programming the DVR for recording.

4. The selective recording apparatus of claim 3 where the prohibited list identifies video programs that were previously recorded by the DVR and deleted without being viewed by a user.

5. The selective recording apparatus of claim 3 where the prohibited list identifies video programs that were previously recorded by the DVR and substantially completely viewed by a user.

6. The selective recording apparatus of claim 1 further including a memory for storing the DVR programming.

7. The selective recording apparatus of claim 1 further including a memory for storing the user recording history.

8. The selective recording apparatus of claim 1 further including an interactive interface for presenting user-selectable filtering criteria used by the preference engine to a user.

9. The selective recording apparatus of claim 8 where the interactive interface is arranged to receive user input responsive to the user-selectable filtering criteria.

10. A method of recording video programs on a DVR, the method comprising:
obtaining metadata associated with one or more entries in a list of video programs available to the DVR for recording;
filtering entries from the list of video programs using the metadata to thereby generate a subset list of video programs having both first run episodes and rerun episodes; and
programming the DVR for recording responsively to the subset list of video programs.

11. The method of claim 10 further including enabling a user to set the DVR to record first run episodes of video programs that are saved on the DVR until manually deleted.

12. The method of claim 10 further including enabling a user to set the DVR to record first run episodes of video programs in the subset list.

13. The method of claim 12 further including enabling a user to set the DVR to save recorded first run episodes of video programs in the subset list.

13. The method of claim 10 further including enabling a user to set a user-selectable number of rerun episodes of video programs to be recorded by the DVR.

14. The method of claim 13 where the recorded rerun episodes of the video program are saved on the DVR until manually deleted by the user.

15. The method of claim 13 where the recorded rerun video programs are saved on the DVR until refreshed by newer recorded rerun video programs.

16. The method of claim 10 where the list of video programs available to the DVR for recording comprises EPG data.

17. The method of claim 10 where the metadata comprises EPG data.

18. The method of claim 10 where the metadata is sourced from an external database.

19. The method of claim 18 where the external database is accessed from the Internet.

20. At least one computer-readable medium encoded with instructions which, when executed by a processor, performs a method comprising:
obtaining a list of video programs available to the DVR for recording;
filtering entries from the list of video programs using a user recording history to generate a prohibited list of video programs; and
programming the DVR for recording responsively to the prohibited list of video programs.

21. The at least one computer-readable medium of claim 20 where the prohibited list includes identities of video programs that were previously recorded and deleted without being watched by the user during a time period.

22. The at least one computer-readable medium of claim 21 where the time period is user-selectable.

23. The at least one computer-readable medium of claim 21 where the user recording history includes data indicative of video programming recorded and deleted on the DVR during a time interval.

24. The at least one computer-readable medium of claim 23 where the user history further includes data indicative of an extent to which video programming is watched by the user.

25. The at least one computer-readable medium of claim 23 where the user history further includes data indicative of frequency at which video programming is watched by the user.
